(19) United States
(12) Patent Application Publication
(10) Pub. No.: US 2008/0166573 A1
(43) Pub. Date: Jul. 10, 2008

(54) Hydrogens Storage Structure

(75) Inventors: Tamio Shinozawa, Shizuoka (JP); Tomoya Matsunaga, Fribourg (CH)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/885,321

(22) PCT Filed: Mar. 31, 2006
(86) PCT No.: PCT/JP06/07390

§ 371 Date: Aug. 30, 2007

(30) Foreign Application Priority Data
Mar. 31, 2005 (JP) 2005-105085

(51) Int. Cl. B32B 15/04; C01B 3/00

(52) U.S. Cl. 428/457

(57) ABSTRACT

A hydrogen storage structure, of which a hydrogen absorption amount is large and a hydrogen absorption rate in the vicinity of room temperature is fast, is provided. The hydrogen storage structure comprises a hydrogen absorption layer, which includes Mg or a Mg-based hydrogen absorption alloy, and hydrogen diffusion layers, which are disposed so as to sandwich the hydrogen absorption layer and include a hydrogen diffusion material.

### FIELD OF THE INVENTION

The present invention relates to a hydrogen storage structure which has a layered structure.

### DESCRIPTION OF THE RELATED ART

Because of the rise of environmental problems, energy problems and the like in recent years, the development of fuel cell motor vehicles is being carried out vigorously. Storage of hydrogen gas is one major issue for the development of fuel cell motor vehicles, and development of high-density hydrogen absorption materials for fuel cell motor vehicles is being called for.

As examples of hydrogen absorption materials, room temperature absorption materials, typified by TiCrV-based hydrogen absorption alloys, are cited. However, for TiCrV-based hydrogen absorption alloys, development has stagnated at hydrogen absorption amounts of somewhat more than 2% by mass. In contrast thereto, experiments have been performed using light elements, typified by magnesium (Mg) and the like as the storage amounts of hydrogen are large. However, Mg-based hydrogen absorption alloys have a problem in lacking suitability in practice because, although hydrogen storage amounts are large, high temperatures of 350° C. and above are necessary for absorption and release of hydrogen, and absorption and release rates of hydrogen are slow. Consequently, various experiments have been performed in order to improve hydrogen absorption and release characteristics of Mg-based hydrogen absorption alloys. For example, in the publication of Japanese Patent Application Laid-Open (JP-A) No. 2002-105576, a hydrogen storage layered structure is disclosed which is provided with a hydrogen absorption layer, at which Mg or a Mg-based alloy is formed into a thin film, and a pair of hydrogen transfer layers, which are laminated so as to sandwich this hydrogen absorption layer. Further, in the publication of JP-A No. 2004-66653 and the publication of JP-A No. 2004-346418, technologies relating to multi-layer structures of hydrogen absorption materials have been disclosed.

The hydrogen absorption layered structure disclosed in the publication of JP-A No. 2002-105576 has a structure in which hydrogen transfer layers, which functions as catalytic layers causing hydrogen gas to dissociate to the atomic form, are disposed at both sides of a hydrogen absorption layer, which is structured of Mg or the like. Further, as an Example, a hydrogen absorption layered structure with a three-layer formation is cited, in which a pair of palladium layers are disposed at both sides of a magnesium layer. However, a hydrogen absorption rate of this hydrogen absorption layered structure in the vicinity of ordinary temperatures is not satisfactory.

With a hydrogen storage layered structure described in the Example of the publication of JP-A No. 2002-105576, in which Mg or a Mg-based hydrogen storage alloy is sandwiched with Pd layers or the like, or a multi-layer structure hydrogen absorption body described in the publication of JP-A No. 2004-66653 and a multi-layer structure described in the publication of JP-A No. 2004-346418, it is difficult to perform hydrogen absorption/release at less than 350° C. with a high speed.

There are cases in which a hydrogen absorption material is employed with a predetermined granularity. However, because bulk density of a granular body is around 60% of true density, a density will be remarkably lowered in a case in which a light alloy of Mg or the like is used. Consequently, it is difficult to greatly improve hydrogen absorption amounts in relation to volume.

### SUMMARY OF THE INVENTION

The present invention has been devised in consideration of the problematic points of the above-described prior art, and provides a hydrogen storage structure of which a hydrogen absorption amount is large and a hydrogen absorption rate in the vicinity of room temperature is fast.

A first aspect of the present invention is a hydrogen storage structure comprising; a hydrogen absorption layer including Mg or a Mg-based hydrogen absorption alloy, and a pair of hydrogen diffusion layers including hydrogen diffusion material, which are disposed so as to sandwich the hydrogen absorption layer.

A second aspect of the present invention is a hydrogen storage structure comprising alternately provided plural hydrogen absorption layers including Mg or a Mg-based hydrogen absorption alloy, and plural hydrogen diffusion layers including hydrogen diffusion material.

In each of the aspects described above, a hydrogen equilibrium pressure of the hydrogen diffusion material at 25° C. may be at least 0.1 MPa and be higher than a hydrogen equilibrium pressure of the Mg or Mg-based hydrogen absorption alloy at 25° C.

In each of the aspects described above, the hydrogen diffusion material may be at least one selected from TiMn, TiCr, TiFe, Ti and V.

In each of the aspects described above, the hydrogen diffusion material may be material which is stable with respect to hydrogen, with a hydrogen diffusion coefficient of the hydrogen diffusion material at 25° C. being higher than a hydrogen diffusion coefficient of the Mg or Mg-based hydrogen absorption alloy at 25° C.

In each of the aspects described above, the hydrogen diffusion material may be Ni.

In each of the aspects described above, a hydrogen dissociation layer including hydrogen dissociation material may be further provided as an outermost layer.

According to the present invention, a hydrogen storage structure of which a hydrogen storage amount is large and a hydrogen absorption rate in the vicinity of room temperature is fast can be provided.

### BRIEF DESCRIPTIONS OF THE DRAWINGS

FIG. 1 is a perspective view representing a hydrogen storage structure of the present invention which relates to a first embodiment.

FIG. 2 is a perspective view representing a hydrogen storage structure of the present invention which relates to a second embodiment.

FIG. 3 is a perspective view representing a hydrogen storage structure of the present invention which relates to a third embodiment.

FIG. 4 is a schematic structural view of a PCT apparatus.

FIG. 5 is a transmission electron microscopic image of a cross-section of a hydrogen storage structure #35.

FIG. 6 is a chart showing temperature dependency characteristics of hydrogen release amounts of hydrogen storage structures #33 to #35.

### DETAILED DESCRIPTION OF THE INVENTION

A hydrogen storage structure of the present invention will be described in detail.

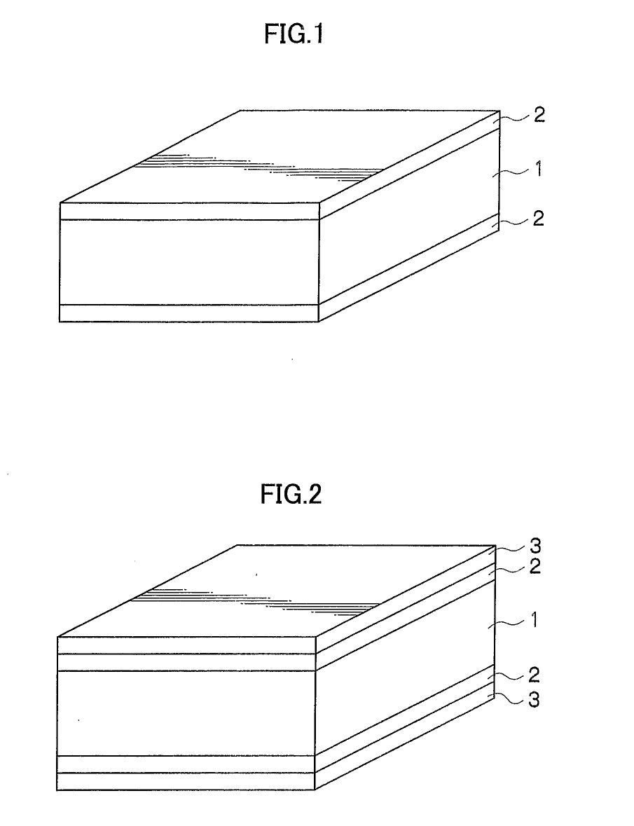

FIG. 1 is a perspective view representing a hydrogen storage structure of the present invention which relates to a first embodiment. The hydrogen storage structure of this embodiment comprises; a hydrogen absorption layer 1 including Mg or a Mg-based hydrogen absorption alloy, and a pair of hydrogen diffusion layers 2 including a hydrogen diffusion material, which are disposed so as to sandwich the hydrogen absorption layer 1.

The Mg or Mg-based hydrogen absorption alloy included at the hydrogen absorption layer 1 is of a high hydrogen storage amount and has a hydrogen absorption/release temperature at 350 to 400° C. while poor hydrogen absorption/release at room temperature. The hydrogen diffusion material included in the hydrogen diffusion layer 2 exhibits high speed diffusion movement of hydrogen atoms. Hydrogen atoms ingress into the hydrogen diffusion layers 2 through a front face and a rear face of the hydrogen diffusion layers 2, quickly move by diffusion in the hydrogen diffusion layers 2, and are stored as metal hydrides combined with the Mg or Mg-based hydrogen absorption alloy included at the hydrogen absorption layer 1. Consequently, the hydrogen storage structure of the present invention enables hydrogen absorption at room temperature at a high speed. Note that a room temperature for the present invention means ordinary atmospheric temperatures, and represents around 0 to 40° C.

Further, the Mg or Mg-based hydrogen absorption alloy oxidizes easily, and could react with oxygen or water to generate heat or the like. However, because the hydrogen absorption layer 1 is sandwiched by the pair of hydrogen diffusion layers 2, the Mg or Mg-based hydrogen absorption alloy does not directly contact the atmosphere, and the hydrogen storage structure of the present invention enables safe handling.

The Mg-based hydrogen absorption alloy which is used in the present invention, for example, is MgNi, MgAl, MgB and the like. The hydrogen absorption layer 1 preferably contains one kind of hydrogen absorption material selected from MgNi and Mg, and more preferably contains Mg.

The hydrogen diffusion material is not particularly limited as long as the material exhibits a diffusion movement of hydrogen atoms at high speed. However, for example, such a material is preferable as exhibiting a hydrogen equilibrium pressure at 25° C. of at least 0.1 MPa which is higher than a hydrogen equilibrium pressure at 25° C. of the Mg or Mg-based hydrogen absorption alloy. By using such a material, hydrogen diffusion characteristics at room temperature becomes favorable, and hydrogen absorption temperatures and hydrogen absorption rates can be greatly improved.

At least one selected from, for example, TiMn, TiCr, TiFe, Ti and V is cited as a material which exhibits a hydrogen equilibrium pressure at 25° C. of at least 0.1 MPa which is higher than a hydrogen equilibrium pressure at 25° C. of the Mg or Mg-based hydrogen absorption alloy,

The hydrogen equilibrium pressure of a material can be found from a PCT curve measured by a PCT (Pressure-Composition-Temperature; the same hereafter) apparatus (Sieverts' method).

A material which is stable with respect to hydrogen and of which a hydrogen diffusion coefficient at 25° C. is higher than a hydrogen diffusion coefficient of the Mg or Mg-based hydrogen absorption alloy at 25° C. is also preferable as the hydrogen diffusion material used in the present invention. For the present invention, a hydrogen diffusion material being stable with respect to hydrogen includes such materials that do not generate hydrides in an atmosphere in which the hydrogen storage structure of the present invention is employed.

The hydrogen absorption layer 1 contracts or expands due to the Mg or Mg-based hydrogen absorption alloy absorbing or releasing hydrogen. The hydrogen diffusion layer 2 including the hydrogen diffusion material, which is resistant to creating hydrides, also expands or contracts (changes in volume), though the volume variation is different from that of the hydrogen absorption layer 1. Consequently, tensile strain is applied to the hydrogen absorption layer 1 which has absorbed hydrogen and contracted, such that the hydrogen absorption layer 1 does not contract from the hydrogen diffusion layers 2 at which a volume change hardly occurs or which expand, and hydrogen absorption is performed smoothly. As a result, hydrogen absorption can be realized at low temperatures.

Ni or the like is cited as examples of a material which is stable with respect to hydrogen and of which a hydrogen diffusion coefficient at 25° C. is higher than a hydrogen diffusion coefficient of the Mg or Mg-based hydrogen absorption alloy at 25° C.

The hydrogen diffusion coefficient of a material can be measured by an electrochemical emission method or a thermal desorption method.

A thickness of the hydrogen absorption layer 1 is preferably 10 to 1000 nm, and 10 to 100 nm is more preferable. If the thickness of the hydrogen absorption layer 1 is 10 to 1000 nm, rapid hydrogen absorption and release can be realized.

A thickness of the hydrogen diffusion layer 2 is preferably 1 to 150 nm, and 10 to 100 nm is more preferable. If the thickness of the hydrogen diffusion layer 2 is 1 to 150 nm, rapid hydrogen absorption and release can be realized.

A ratio A/B of a thickness A of the hydrogen absorption layer 1 and a thickness B of the hydrogen diffusion layers 2 (a total of thicknesses of a pair of the hydrogen diffusion layers 2) is preferably 1.5 or more, and 2 or more is more preferable. If A/B is 1.5 or more, rapid hydrogen absorption and release can be realized. Further, in order to prevent a remarkable increase in hydrogen absorption duration due to A/B being excessively large, A/B is preferably not more than 10.

Shape, size and the like of the hydrogen storage structure relating to the first embodiment are not particularly limited. However, a shorter side length of the hydrogen storage structure is preferably not more than 20 cm. By setting the shorter side length of the hydrogen storage structure to 20 cm or less, rapid hydrogen absorption and release can be realized.

FIG. 2 is a perspective view representing a hydrogen storage structure of the present invention which relates to a second embodiment. The hydrogen storage structure is further provided with hydrogen dissociation layers 3 including a hydrogen dissociation material at outermost layers of the hydrogen storage structure of the first embodiment. The hydrogen storage structure of the second embodiment is provided with the hydrogen dissociation layers 3 at both faces thereof, but could be provided with the hydrogen dissociation layer 3 only at the face of one side.

The hydrogen dissociation material acts as a catalytic which causes hydrogen molecules to dissociate to hydrogen atoms. V and Pd are cited as examples of the hydrogen dissociation material. Among these, Pd, which exhibits a strong catalytic action, is preferable. By providing the hydrogen dissociation layer 3 at the outermost layer, rapid hydrogen absorption can be realized.

For the hydrogen storage structure relating to the second embodiment, a material which is more excellent in hydrogen dissociation capability than the hydrogen diffusion material is used in the hydrogen dissociation layer 3. The comparative merits in hydrogen dissociation capability of individual materials are known; for example, the hydrogen dissociation capability of Pd is more excellent than that of V. Therefore, in a case in which the hydrogen diffusion layer 2 is structured by V, the hydrogen dissociation layer 3 will be structured by Pd.

A thickness of the hydrogen dissociation layer 3 is preferably at most 5 nm. If the thickness of the hydrogen dissociation layer 3 is 5 nm or less, rapid hydrogen absorption can be realized.

Preferable ranges of thickness and preferable materials of the hydrogen absorption layer 1 and the hydrogen diffusion layers 2 relating to the second embodiment, and a preferable range of a shorter side length of the hydrogen storage structure are similar to a case of the first embodiment.

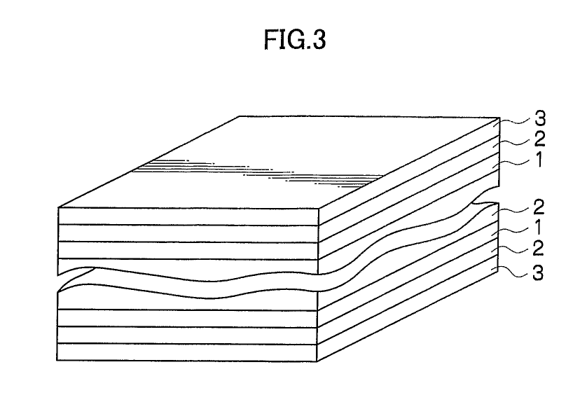

FIG. 3 is a perspective view representing a hydrogen storage structure of the present invention which relates to a third embodiment. The hydrogen storage structure of the third embodiment is alternately provided with the plural hydrogen absorption layers 1 including Mg or a Mg-based hydrogen absorption alloy and the plural hydrogen diffusion layers 2 including a hydrogen diffusion material, and is further provided, at outermost layers, with the hydrogen dissociation layers 3 including a hydrogen dissociation material.

The hydrogen storage structure relating to the third embodiment, which is provided with a plurality of the hydrogen absorption layer, is more excellent in hydrogen absorption rates and hydrogen absorption amounts than the hydrogen storage structure relating to the first embodiment, which is provided with the single-layer hydrogen absorption layer, even if a total thickness of the hydrogen absorption layers is same. This is thought to be because a contact area between the hydrogen diffusion layers 2 and the hydrogen absorption layers 1 is larger while diffusion distances are shorter by providing the plural hydrogen absorption layers instead of a single layer. A hydrogen absorption material of Mg or the like differs from hydrogen absorption materials of so-called room temperature types and, rather than dissolving hydrogen, forms hydrides (ionic bonding) such as MgH₂ and stores the hydrogen. The formed MgH₂ itself hinders hydrogen diffusion, and it is thought that at a point when a material surface is hydrogenated, subsequent hydrogen diffusion becomes tardiness. However, by alternately providing the hydrogen absorption layers 1 and the hydrogen diffusion layers 2 one after another, the contact area of the hydrogen diffusion layers 2 and the hydrogen absorption layers 1 can be made larger. Consequently, lowering of hydrogen diffusion capacity due to hydrogenation of material surfaces is less likely to be experienced.

In a case in which the hydrogen storage structure is not provided with the hydrogen dissociation layers 3, it is preferable that the hydrogen diffusion layers 2 are provided at the outermost layers. Because of the hydrogen diffusion layers 2 located at the outermost layers, the hydrogen storage structure can be safely handled as the hydrogen absorption layers 1 including Mg or a Mg-based hydrogen absorption alloy do not directly contact the atmosphere.

In the hydrogen storage structure relating to the third embodiment, a layer count of the hydrogen absorption layers 1 and the hydrogen diffusion layers 2 is preferably not less than 10 layers in total, and is particularly preferably not less than 100 layers.

A thickness of each hydrogen absorption layers 1 is preferably 10 to 100 nm, and 10 to 50 nm is more preferable. If the thickness of the hydrogen absorption layer 1 is 10 to 100 nm, rapid hydrogen absorption and release can be realized.

A thickness of each hydrogen diffusion layer 2 is preferably 1 to 10 nm, and 1 to 5 nm is more preferable. If the thickness of the hydrogen diffusion layer 2 is 1 to 10 nm, rapid hydrogen absorption and release can be realized.

A thickness of each hydrogen dissociation layer 3, if provided, is preferably at most 5 nm. If the thickness of the hydrogen dissociation layer 3 is 5 nm or less, rapid hydrogen absorption and release can be realized.

A ratio A/B of a thickness A of the hydrogen absorption layers 1 (a total of thicknesses of all the hydrogen absorption layers 1) and a thickness B of the hydrogen diffusion layers 2 (a total of thicknesses of all the hydrogen diffusion layers 2) is preferably at least 1, at least 5 is more preferable, and at least 10 is most preferable. If A/B is 1 or more, rapid hydrogen absorption and release can be realized. Note that when the hydrogen dissociation layer is provided, the thickness B includes total thicknesses of all the hydrogen diffusion layers 2 and all the hydrogen dissociation layers 3

Further, in order to prevent a hydrogen absorption duration becoming several hours or more, A/B is preferably not more than 50.

A preferable range of a shorter side length of the hydrogen storage structure relating to the third embodiment and so forth are similar to a case of the first embodiment.

A fabrication method of the hydrogen storage structure of the present invention is not particularly limited, and fabrication would be possible using well-known thin film formation methods, such as sputtering methods, flash evaporation methods and so forth.

### EXAMPLES

Herebelow, referring to Examples, the present invention will be more specifically described. However, the present invention is not limited by the following Examples.

—Fabrication of Hydrogen Storage Structure—

Using a multi-source sputtering apparatus, hydrogen storage structures #1 to #35 were fabricated by laminating hydrogen absorption layers, hydrogen diffusion layers and, in accordance with requirements, hydrogen dissociation layers onto an A4-size aluminum thin film based on the structures described in Table 1 to Table 5.

—Measurement of Hydrogen Absorption Amounts—

Hydrogen absorption amounts were measured by a PCT apparatus.

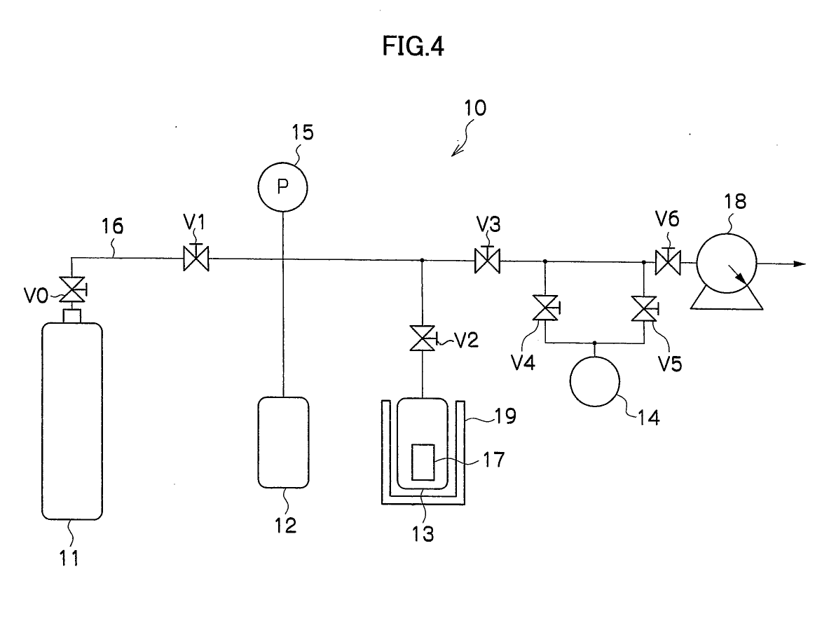

FIG. 4 is a diagram showing schematic structure of the PCT apparatus. In an apparatus 10, a hydrogen cylinder 11, a buffer container 12, a sample container 13, a vacuum pump 14, a pressure gauge 15 and a wet-type flowmeter 18 are connected via piping 16. Valves V0 to V6 are provided at the piping 16. The sample container 13 is covered with a heater 19, such that a hydrogen storage structure in the sample container 13 (for example, a measurement sample 17) is heated.

First, in a state in which the valves V0, V5 and V6 are closed and the valves V1 to V4 are opened, the vacuum pump 14 is operated until pressure in the buffer container 12, the sample container 13 and the piping 16 is at or below a predetermined pressure.

When pressure in the buffer container 12, the sample container 13 and the piping 16 is at or below the predetermined pressure, the valve V3 is closed and the vacuum pump 14 is stopped.

The valve V2 is closed, the valve V0 is opened and hydrogen gas is charged into the buffer container 12. Thereafter, the valve V0 and the valve V1 are closed. A pressure which is measured by the pressure gauge 15 at this time is defined as P0. Then, the valve V2 is opened and pressure of the buffer container 12 and the sample container 13 is made constant. A pressure which is measured by the pressure gauge 15 at this time is defined as P1. The hydrogen absorption amounts (mass %) are found from a pressure difference between the pressures P0 and P1. Incidentally, this system is commonly known as the Sieverts' method (a volumetric method).

—Measurement of Released Hydrogen Amounts—

In the apparatus 10 shown in FIG. 4, in states in which the measurement sample 17 at which hydrogen has been absorbed, for example, is disposed in the sample container 13, which is heated to predetermined temperatures by the heater 19, and the valves V0 to V2, V4 and V5 are closed and the valves V3 and V6 are opened, released hydrogen amounts are found by guiding hydrogen released at each temperature into the wet-type flowmeter 18 and measuring hydrogen volumes.

Further, based on the released hydrogen amounts that are obtained, volume storage densities are found. Here, a volume storage density indicates a volume of hydrogen gas which is stored per unit volume of the hydrogen storage structure.

For the hydrogen storage structures #1 to #4 fabricated by the method described above, a 90% hydrogen absorption duration (an absorption duration) and a 90% hydrogen release duration (a release duration) were found at predetermined temperatures. The results obtained are shown in table 1. Note that the 90% hydrogen absorption duration means a duration required for absorbing hydrogen in an amount of 90% of a maximum hydrogen absorption amount of respective hydrogen storage structures #1 to #4, and the 90% hydrogen release duration means a duration required for releasing hydrogen in an amount of 90% of the maximum hydrogen absorption amount of respective hydrogen storage structures #1 to #4.

TABLE 1

| | Structure | | | | | | | | | |
|---|---|---|---|---|---|---|---|---|---|---|
| | Hydrogen | | Hydrogen | | Hydrogen | | Absorption | | Release | |
| | absorption | | diffusion | | dissociation | | | Absorption | | Release |
| | layer | | layer | | layer | | Temp. | duration | Temp. | duration |
| Example | | nm | | nm | | nm | (° C.) | (min.) | (° C.) | (min.) |
| #1 | Mg | 800 | TiMn | 40 | Pd | 20 | 150 | 20 | 300 | 8 |
| | | | | | | | 90 | (2 hrs) | 250 | — |
| #2 | Mg | 800 | TiFe | 40 | Pd | 20 | 150 | 35 | 300 | 12 |
| | | | | | | | 90 | (3 hrs) | 250 | — |
| #3 | Mg | 800 | Ni | 40 | Pd | 20 | 150 | 15 | 300 | 14 |
| | | | | | | | 90 | (2 hrs) | 250 | — |

| | | | | | |
|---|---|---|---|---|---|
| #4 | Mg thin film (70 μm thick) | 300 | 30 | 400< | 90% |
| | | | | | release not |
| | | | | | possible |

As shown in table 1, it is understood that the hydrogen storage structures #1 to #3 relating to the present invention are capable of absorbing hydrogen at 150° C. and releasing hydrogen at 300° C. It is understood that, in comparison with the hydrogen storage structure #4, which is a Mg thin film, hydrogen absorption characteristics and hydrogen release characteristics are improved.

For the hydrogen storage structures #5 (the same as #1) to #7 fabricated by the method described above, 90% hydrogen absorption durations (absorption durations) and 90% hydrogen release durations (release durations) at predetermined temperatures were found. The results obtained are shown in table 2.

TABLE 2

| | Structure | | | | | | | | | |
|---|---|---|---|---|---|---|---|---|---|---|
| | Hydrogen | | Hydrogen | | Hydrogen | | Absorption | | Release | |
| | absorption | | diffusion | | dissociation | | | Absorption | | Release |
| | layer | | layer | | layer | | Temp. | duration | Temp. | duration |
| Example | | nm | | nm | | nm | (° C.) | (min.) | (° C.) | (min.) |
| #5 | Mg | 800 | TiMn | 40 | Pd | 20 | 150 | 20 | 300 | 8 |
| #6 | Mg | 250 | TiMn | 40 | Pd | 20 | 150 | 2 | 300 | 4 |
| #7 | Mg | 160 | TiMn | 40 | Pd | 20 | 150 | 1 | 250 | 2 |

From table 2, it is understood that it is possible to lower a hydrogen release temperature by making the thickness of the hydrogen absorption layer thinner.

For the hydrogen storage structures #8 to #18 fabricated by the method described above, hydrogen absorption amounts, volume storage densities and 90% hydrogen absorption durations at 25° C. were found. The results obtained are shown in table 3.

TABLE 3

| | Structure | | | | | | | | | | | | |
|---|---|---|---|---|---|---|---|---|---|---|---|---|---|
| | Hydrogen | | | Hydrogen | | | Hydrogen | | | | | | |
| | absorption | | | diffusion | | | dissociation | | | | | | |
| | layer | | | layer | | | layer | | | | Absorption characteristics | | |
| | | nm × | | | nm × | | | nm × | | | Hydrogen | Volume | Absorption |
| | | layer | | | layer | | | layer | | | absorption | storage | duration |
| Example | | count | | | count | | | count | | A/B | amount | density | (min.) |
| #8 | Mg | 600 | 1 | Ni | 40 | 2 | Pd | 0 | 0 | 7.5 | 5.7 | 2250 | 1500 |
| #9 | Mg | 160 | 1 | Ni | 40 | 2 | Pd | 0 | 0 | 2 | 3.2 | 2000 | 120 |
| #10 | Mg | 100 | 1 | Ni | 40 | 2 | Pd | 0 | 0 | 1.25 | 2.5 | 1800 | 70 |
| #11 | Mg | 5 | 1 | Ni | 1.25 | 2 | Pd | 0 | 0 | 2 | 3.3 | 2100 | 5 days |
| #12 | Mg | 100 | 1 | Ni | 20 | 2 | Pd | 0 | 0 | 2.5 | 4 | 2200 | 50 |
| #13 | Mg | 200 | 1 | Ni | 20 | 2 | Pd | 0 | 0 | 5 | 5 | 2300 | 180 |
| #14 | Mg | 10 | 1 | Ni | 0.5 | 2 | Pd | 1 | 2 | 3.3 | 6 | 2100 | 5 days |
| #15 | Mg | 10 | 1 | Ni | 2 | 2 | Pd | 1 | 2 | 1.7 | 3.8 | 2200 | 1200 |
| #16 | Mg | 800 | 1 | Ni | 150 | 2 | Pd | 1 | 2 | 2.6 | 3.9 | 2200 | 2600 |
| #17 | Mg | 800 | 1 | Ni | 200 | 2 | Pd | 1 | 2 | 2 | 3.3 | 2100 | 2100 |
| #18 | Mg | 800 | 1 | Ni | 200 | 2 | Pd | 0 | 0 | 2 | 3.4 | 2100 | 2700 |

From table 3, it is understood that hydrogen absorption at 25° C. is possible. Further, the following are understood.

(1) From the results of the hydrogen storage structures #8 to #10, it is understood that, when the hydrogen dissociation layer is not provided, hydrogen storage structures which are excellent in 90% hydrogen absorption duration can be obtained by forming the hydrogen absorption layer to be thin.

(2) From the results of the hydrogen storage structures #11 to #13, it is understood that, when the hydrogen dissociation layer is not provided, the hydrogen absorption amount at 25° C. is large and 90% hydrogen absorption duration can be shortened by setting the thickness of the hydrogen absorption layer to 100 nm or more (and A/B to 2 or more).

(3) From the results of the hydrogen storage structures #14 to #17, it is understood that in cases that the hydrogen dissociation layer is provided, hydrogen storage structures which are excellent in hydrogen absorption amount, volume storage density and 90% hydrogen absorption duration at 25° C. can be obtained by setting A/B to 1.7 to 2.6.

(4) From the results of the hydrogen storage structures #17 and #18, it is understood that the hydrogen absorption rates differ due to presence or absence of the hydrogen dissociation layers (Pd).

For the hydrogen storage structures #19 to #32 fabricated by the method described above, hydrogen absorption amounts, volume storage densities and 90% hydrogen absorption durations at 25° C. were found. The results obtained are shown in table 4.

TABLE 4

| | Structure | | | | | | | | | | | | |
|---|---|---|---|---|---|---|---|---|---|---|---|---|---|
| | Hydrogen | | | Hydrogen | | | Hydrogen | | | | | | |
| | absorption | | | diffusion | | | dissociation | | | | Absorption characteristics | | |
| | layer | | | layer | | | layer | | | | Hydrogen | Volume | Absorption |
| | | nm × layer | | | nm × layer | | | nm × layer | | | absorption | storage | duration |
| Example | | count | | | count | | | count | | A/B | amount | density | (min.) |
| #19 | Mg | 10 | 2 | Ni | 2 | 3 | Pd | 2 | 2 | 2 | 1.9 | 1700 | 5 days |
| #20 | Mg | 10 | 11 | Ni | 2 | 2 | Pd | 2 | 2 | 3.9 | 3.4 | 2200 | 300 |
| #21 | Mg | 22 | 5 | Ni | 2 | 6 | Pd | 2 | 2 | 6.9 | 4.5 | 2400 | 1300 |
| #22 | Mg | 22 | 11 | Ni | 2 | 12 | Pd | 2 | 2 | 8.6 | 4.9 | 2400 | 330 |
| #23 | Mg | 22 | 100 | Ni | 2 | 101 | Pd | 2 | 2 | 11 | 5.1 | 2300 | 7 |
| #24 | Mg | 6 | 150 | Ni | 2 | 151 | Pd | 2 | 2 | 2.9 | 2.8 | 1900 | 2 |
| #25 | Mg | 10 | 150 | Ni | 2 | 151 | Pd | 2 | 2 | 5 | 3.7 | 2200 | 3 |
| #26 | Mg | 30 | 150 | Ni | 2 | 151 | Pd | 2 | 2 | 15 | 5.6 | 2300 | 6 |
| #27 | Mg | 100 | 150 | Ni | 2 | 151 | Pd | 2 | 2 | 49 | 6.9 | 1900 | 43 |
| #28 | Mg | 200 | 150 | Ni | 2 | 151 | Pd | 2 | 2 | 99 | 7.2 | 1700 | 170 |
| #29 | Mg | 22 | 150 | Ni | 0.5 | 151 | Pd | 2 | 2 | 41.5 | 7.4 | 1600 | 80 |
| #30 | Mg | 22 | 150 | Ni | 2 | 151 | Pd | 2 | 2 | 10.8 | 6.9 | 1800 | 43 |
| #31 | Mg | 22 | 150 | Ni | 10 | 151 | Pd | 2 | 2 | 2.2 | 5 | 2300 | 40 |
| #32 | Mg | 22 | 150 | Ni | 20 | 151 | Pd | 2 | 2 | 1.1 | 3.5 | 2200 | 40 |

From table 4, it is understood that hydrogen absorption at 25° C. is possible. Further, the following are understood.

(1) From the results of the hydrogen storage structures #19 and #20, it is understood that 90% hydrogen absorption duration of the hydrogen storage structure can be shortened by providing the layer count of the hydrogen absorption layers to be large.

(2) From the results of the hydrogen storage structures #21 to #23, it is understood that hydrogen absorption amounts and 90% hydrogen absorption durations improve as the layer counts of the hydrogen absorption layers and the hydrogen diffusion layers become larger.

(3) From the results of the hydrogen storage structures #24 to #28, it is understood that in cases in which the layer counts of the hydrogen absorption layers and the hydrogen diffusion layers are large, hydrogen storage structures which are excellent in 90% hydrogen absorption duration can be obtained by providing the thickness of each hydrogen absorption layers to be thin.

(4) From the results of the hydrogen storage structures #29 to #32, it is understood that in cases in which the layer counts of the hydrogen absorption layers and the hydrogen diffusion layers are large, hydrogen storage structures which are excellent in 90% hydrogen absorption duration can be obtained by providing the thickness of each hydrogen diffusion layers to be thick.

(5) Further, from the results of the hydrogen storage structures #24 to #32 it is also understood that in cases in which the layer counts of the hydrogen absorption layers and the hydrogen diffusion layers are large, hydrogen storage structures which are excellent in 90% hydrogen absorption duration can be obtained by setting A/B at 1 to 15.

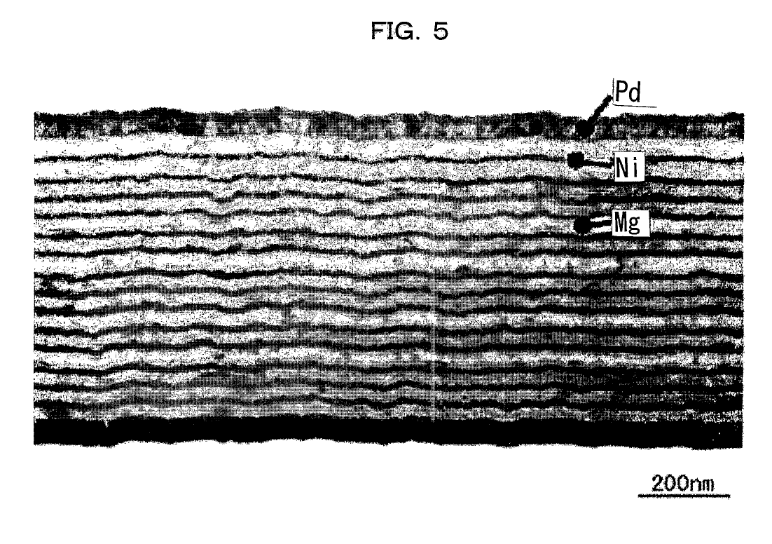

The hydrogen storage structures #33 to #35, fabricated by the method described above, were such that hydrogen diffusion layers of thickness 60 nm bordered with the hydrogen dissociation layers. A transmission electron microscopic image of a cross-section of the hydrogen storage structure #35 is shown in FIG. 5.

TABLE 5

| | Structure | | | | | |
|---|---|---|---|---|---|---|
| | Hydrogen | | Hydrogen | | Hydrogen | |
| | absorption | | diffusion | | dissociation | |
| | layer | | layer | | layer | |
| | | nm × layer | | nm × layer | | nm × layer |
| Example | | count | | count | | count |
| #33 | Mg | 44 × 15 | TiFe | 5 × 14 | Pd | 20 |
| | | | | 60 × 2 | | |
| #34 | Mg | 33 × 15 | TiMn | 14 × 14 | Pd | 20 |
| | | | | 60 × 2 | | |
| #35 | Mg | 40 × 15 | Ni | 14 × 14 | Pd | 20 |

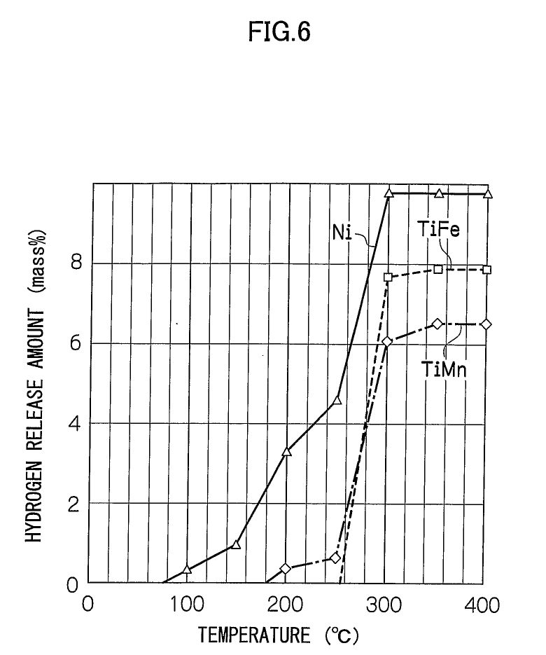

Using the hydrogen storage structures #33 to #35, temperature dependency characteristics of hydrogen release amounts were investigated. The results obtained are shown in FIG. 6. From FIG. 6, it is understood that hydrogen release can be realized from less than 100° C. by using Ni as the hydrogen diffusion material.

### INDUSTRIAL APPLICABILITY

According to the present invention, it is possible to provide a hydrogen storage structure of which a hydrogen storage amount is large and a hydrogen absorption rate in the vicinity of room temperature is fast.

1. A hydrogen storage structure comprising:
a hydrogen absorption layer including Mg or a Mg-based hydrogen absorption alloy; and
a pair of hydrogen diffusion layers including a hydrogen diffusion material, which are disposed so as to sandwich the hydrogen absorption layer.

2. A hydrogen storage structure comprising:
plural hydrogen absorption layers including Mg or a Mg-based hydrogen absorption alloy; and
plural hydrogen diffusion layers including a hydrogen diffusion material;
wherein the hydrogen absorption layers and the hydrogen diffusion layers are alternately provided.

3. The hydrogen storage structure according to claim 1, wherein a hydrogen equilibrium pressure of the hydrogen diffusion material at 25° C. is at least 0.1 MPa and is higher than a hydrogen equilibrium pressure of the Mg or Mg-based hydrogen absorption alloy at 25° C.

4. The hydrogen storage structure according to claim 1, wherein the hydrogen diffusion material is at least one selected from TiMn, TiCr, TiFe, Ti and V.

5. The hydrogen storage structure according to claim 1, wherein the hydrogen diffusion material is stable with respect to hydrogen, and a hydrogen diffusion coefficient of the hydrogen diffusion material at 25° C. is higher than a hydrogen diffusion coefficient of the Mg or Mg-based hydrogen absorption alloy at 25° C.

6. The hydrogen storage structure according to claim 1, wherein the hydrogen diffusion material is Ni.

7. The hydrogen storage structure according to claim 1, wherein a hydrogen dissociation layer including a hydrogen dissociation material is further provided as an outermost layer thereof.
